(19) United States
(12) Patent Application Publication
(10) Pub. No.: US 2024/0036071 A1
(43) Pub. Date: Feb. 1, 2024

(54) APPARATUS AND A METHOD FOR DETERMINING THE POSITION OR STATE OF A DOOR

(71) Applicant: INSURE FIRETEC LTD, Suffolk (GB)

(72) Inventors: Glen HALL, Suffolk (GB); Justin STAINES, Suffolk (GB)

(21) Appl. No.: 18/256,432

(22) PCT Filed: Dec. 9, 2021
(86) PCT No.: PCT/GB2021/053231

§ 371 Date: Jun. 8, 2023

(30) Foreign Application Priority Data
Dec. 11, 2020 (GB) 2019570.7

(51) Int. Cl. G01P 15/18; G01P 1/00; G06N 7/02

(52) U.S. Cl. CPC G01P 15/18; G01P 1/00; G06N 7/023

(57) ABSTRACT

A method of estimating a precise position of a door by receiving data from a micro-electromechanical six-axis accelerometer, is provided and includes at least the steps of:
applying the six-axis data to a symplectic geometry;
measuring each dynamic function as a linear combination of energy states in each axis;
differentiating to form six differentiations sets of six quantised states;
applying an unsupervised machine learning model including a fuzzy logic engine and outputting an estimate of the precise position of the door.

### FIELD OF THE INVENTION

The present inventive concept relates to apparatus and a method for determining the position or state of a door or similar device.

### BACKGROUND TO THE INVENTION

A known method of measuring door position is to have external magnetic or hall effect sensors at the edge of the door and the edge of the door frame. Another known solution is to use an electromechanical sensor system which is embedded in the sensors retrieving information from an external door closer arm.

These approaches have drawbacks in that they may not be able to detect the door position other than to give the binary result “closed” or “not closed” and furthermore where a door must meet particular regulations (such as a fire door, for example) it may not be possible to fit accurate sensors to a door within those regulations.

The current state of art includes many methods combining two-axis or hall effect sensors around the periphery of a door including the use of supervised machine learning models which have been trained to recognise the shape and pattern of a door opening and closing.

A supervised machine learning model not only requires training to build a predictive model, when deployed into a system this will mean it is unsuitable to be used out of the box without calibration or training.

Other previously proposed approaches require additional sensors, such as optical proximity sensors or time of flight sensors, or air pressure sensors.

### SUMMARY OF INVENTION

The present inventive concept provides a method of estimating a precise position of a door by receiving data from a micro-electromechanical six-axis accelerometer, comprising at least the steps of:
applying the six-axis data to a symplectic geometry;
measuring each dynamic function as a linear combination of energy states in each axis;
differentiating to form six differentiations sets of six quantised states;
applying an unsupervised machine learning model including a fuzzy logic engine and outputting an estimate of the precise position of the door.

The unsupervised machine learning model may effect at least the steps of:
estimating which differentiation set is a closest match to the fuzzy state;
deciding which state is the closest match and defuzzifying that state into Crisp values; and
based on that decision, either output the door position as a Gini coefficient or look at membership function of different fuzzy states and repeat the estimation step.

The method may further comprise the step of calculating momentum in an opening or closing direction by measuring and recording the totality of conserved momentum of the door and using additional information about the door itself including its mass, opening angle and moment of mass.

The angular momentum and energy observed to open the door can be calculated using L=mvr and the opposing energy to close can be calculated by −L. By differentiating each of the 6 moments using but not limited to a classical differentiation dy/dx a reasonable estimate can be achieved around 82% accuracy of door openness or closeness.

The differentiation step may be effected after the applying step.

The method may be effected by a computer.

The present inventive concept also provides a door accessory system comprising a device comprising a power source, a wireless transmitter and a six-axis accelerometer the device adapted to transmit data from the accelerometer to a remote data processing unit which is adapted to perform the method as described above.

Alternatively, the device may integrally comprise a data processing unit adapted to perform the method as described above.

The data processing unit may be a computer.

References to door will be used throughout for consistency, but the inventive concept could be applied to windows and other constructional elements.

The present inventive concept takes advantage of the law of Conservation of Angular Momentum, in that any of the individual angular momenta can change as long as their sum remains constant. This law is analogous to linear momentum being conserved when the external force on a system is zero.

Angular momentum L {L=rmv} is the product of the radius of rotation r and the linear momentum of the door {p=mv} where v in this case is the equivalent linear (tangential) speed at the radius.

Initially each six of the axis data from the accelerometer is applied to a symplectic geometry. The motion of the door is still a canonical transformation (or symplectic) and this method is normally applied in quantum mechanisation to create a wave function in Hilbert space represented by an Eigen state, and providing a quantisation map. Thus, the aforementioned door may be modelled in Hilbert Space and transposed to symplectic geometry by, for example, a Dirac quantisation calculation such as

$$\vert Ψ 〉 = {\sum }_{n = 0}^{∞} {a}_{n} \vert {Ψ}_{n} 〉 .$$

The moments can be differentiated afterwards. Using this modelling will allow reasonable estimate of approx. 91% accuracy of door openness or closeness.

Alternatively, modelling could be effected by taking each quantised momentum state and surfacing it to a fuzzy logic model which consists of fuzzification, i.e. taking each variable and seeing which part of the set it belongs to, and the percentage ownership function, applying each quantised variable to that stored in the model, and giving a percentage recall for 0 to 100 (referred to as Gini coefficient). After each quantised value is fuzzified it would be defuzzified to give a clear crisp percentage of membership. Using this method we can gain accuracy of door openness or closeness up to 98% accuracy.

By having a multi particle system, it is possible to have a number of trained fuzzified models for various door materials, and using some preprogrammed variables the fuzzy algorithm can automatically calculate the mass and moment to 0.98 Gini coefficient. Using this method is allows just one algorithm which can be used on any door material (wood, metal) and increases efficiency in the code and also ease of installation.

We then measure each dynamic function as a linear combination of energy states in each axis

$$\vert Ψ 〉 = {\sum }_{n = 0}^{∞} {a}_{n} \vert {Ψ}_{n} 〉$$

Each energy state is measured in realtime with a time delay of 82 μs between each measurement (however all axis measurements are taken simultaneously).

Alternatively, instead of Hilbert space for the internal space calculations, Sobolev vector space could be used instead.

We then use a combination of Isaac Newton's classic differentiation equations

$$\frac{dy}{dx} = f ( x ) \\ [ doorangularmomenta ] \frac{dy}{dx} = f ( x , y ) \\ [ doorangularmomenta ] {x}_{1} \frac{\partial y}{\partial {x}_{1}} + {x}_{2} \frac{\partial y}{\partial {x}_{2}} = y$$

We now have six differentiations sets of six quantised states from the six axis movement sensor.

We present these data points up to the fuzzy logic engine, which has been trained with data from a door in a multitude of these states.

Classical logic only allows the representation of a binary (on/off or open/shut) state.

By us creating Fuzzy Sets (U, m). which represent the different door positions we can get a Gini coefficient telling us the probability of the door being open or shut, which is in fact the membership function m: U→[0,1].

For each Fuzzy Set we have created a Crisp Set A=(U, m) and a strong level cut A^{>α}=A′_{α}={x∈U|m(x)>α}.

The next step is defuzzification of the fuzzified differentiated momenta. This is required to give a specific value. For each of these values we will calculate the Gini coefficient. Gini coefficients are generally used in economics for statistical dispersion. Essentially the Gini coefficient can be defined as half of the relative mean absolute difference.

This is the formula we used after defuzzification, n is the number of momenta and i is the single defuzzified number and x is the total:

$$G = \frac{{\sum }_{i = 1}^{n} \sum j = 1 n \vert xi - xj \vert}{2 {\sum }_{i = 1}^{n} {\sum }_{j = 1}^{n} {x}_{j}} = \frac{{\sum }_{i = 1}^{n} \sum j = 1 n \vert xi - xj \vert}{2 n {\sum }_{j = 1}^{n} {x}_{j}} = \frac{{\sum }_{i = 1}^{n} \sum j = 1 n \vert xi - xj \vert}{2 {n}^{2} \overline{x}}$$

For example the following Gini coefficient when presented to our model would indicate a threshold that the door had been opened.

Gₙ(Moment)=0.9632

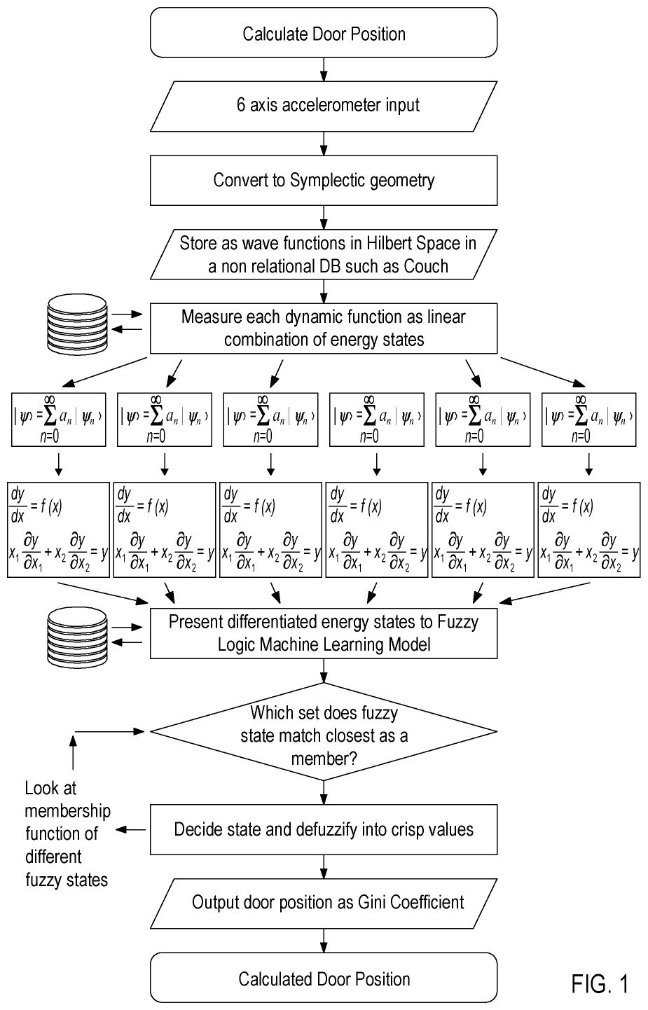

An exemplary embodiment of the above described method is shown as a flow chart in FIG. 1.

1. A method of estimating a precise position of a door by receiving data from a micro-electromechanical six-axis accelerometer, comprising at least the steps of:
applying the six-axis data to a symplectic geometry;
measuring each dynamic function as a linear combination of energy states in each axis;
differentiating to form six differentiations sets of six quantised states;
applying an unsupervised machine learning model including a fuzzy logic engine and outputting an estimate of the precise position of the door.

2. A method according to claim 1, wherein the unsupervised machine learning model effects at least the steps of:
estimating which differentiation set is a closest match to the fuzzy state;
deciding which state is the closest match and defuzzifying that state into Crisp values; and
based on that decision, either output the door position as a Gini coefficient or look at membership function of different fuzzy states and repeat the estimation step.

3. A method according to claim 1, wherein the differentiation step is effected after the applying step.

4. A method according to claim 1, further comprising the step of calculating momentum in an opening or closing direction by measuring and recording the totality of conserved momentum of the door and using additional information about the door itself including its mass, opening angle and moment of mass.

5. A method according to claim 1, implemented by a computer.

6. A door accessory system comprising a device comprising a power source, a wireless transmitter and a six-axis accelerometer, the device adapted to transmit data from the accelerometer to a remote data processing unit which is adapted to perform the method of claim 1.

7. A door accessory system according to claim 6, wherein the device integrally comprises a data processing unit adapted to perform the method comprising at least the steps of:
applying the six-axis data to a symplectic geometry;
measuring each dynamic function as a linear combination of energy states in each axis;
differentiating to form six differentiations sets of six quantised states;
applying an unsupervised machine learning model including a fuzzy logic engine and outputting an estimate of the precise position of the door.
